(19) United States
(12) Patent Application Publication
(10) Pub. No.: US 2010/0063683 A1
(43) Pub. Date: Mar. 11, 2010

(54) AN AID FOR DETECTING DROWSINESS OF A DRIVER OF A VEHICLE

(76) Inventors: Michael Adriaan DIEDRICKS, Witbank (ZA); Pieter Walter HEYDENRYCH, Letnany (CZ)

Correspondence Address: NIXON & VANDERHYE, PC, 901 NORTH GLEBE ROAD, 11TH FLOOR, ARLINGTON, VA, 22203, US

(21) Appl. No.: 11/992,052

(22) PCT Filed: Sep. 15, 2006
(86) PCT No.: PCT/IB2006/053309

§ 371 Date: Mar. 30, 2009

(30) Foreign Application Priority Data
Sep. 15, 2005 (ZA) 2005/07418

(51) Int. Cl. G06F 7/00; B62D 15/02

(52) U.S. Cl. 701/42

(57) ABSTRACT

A detection system (40) suitable for detecting loss of concentration of a driver of a road going vehicle comprising a steering system (22) extending between a steering wheel (24) connected to a steering shaft (26) and road engaging steered wheels (18, 20) of the vehicle, comprises a controller (44) mountable on the vehicle. A first movement sensor A is mountable in a region of the steering wheel (24) or shaft (26), to sense movement of the steering wheel or shaft. The first sensor is connected to the controller (44) to provide the controller with a first signal in response to movement of the steering wheel (24) or shaft (26). The controller (44) is configured to generate an output signal, if there has not been movement of the steering wheel (24) or shaft (26) for a first time period.

### INTRODUCTION AND BACKGROUND

This invention relates to motor vehicles and more particularly to an aid for automatically detecting lack of concentration or drowsiness of a driver of the vehicle and which may be used to warn the driver.

It is well known that many traffic accidents are caused by drivers of vehicles drowsing off or falling asleep and then loosing control over their vehicles. Various road-marking aids are known to assist a driver in such circumstances. For example, in dangerous zones of a road, transversely extending parallel regions with a surface finish other than that of the road in general, are provided. Normally, the finish in these regions is coarser than the general finish of the road surface and the spacing between adjacent regions may decrease, so that when a vehicle is driven over these regions, bursts of audible noise are generated by vehicle wheels negotiating these regions, which bursts have progressively decreasing time intervals between them. These known road-marking techniques are intended to alert the driver that he is entering a dangerous zone. These aids also include a roughened region or strip extending substantially parallel with a side of a lane on the road. Again, as the wheels of the vehicle negotiate this region, a noise is generated by the wheels, which at least warns the driver that he is approaching the side of the lane. The disadvantages of these techniques are that they are not reliable enough and that it is expensive to mark or provide all roads with the necessary rough regions.

### OBJECT OF THE INVENTION

Accordingly, it is an object of the present invention to provide a detection system for detecting loss of concentration or drowsiness of a driver of a vehicle and a method of detecting loss of concentration or drowsiness and warning a driver of a vehicle, with which the applicants believe the aforementioned disadvantages may at least be alleviated.

### SUMMARY OF THE INVENTION

According to the invention there is provided a detection system suitable for use in detecting loss of concentration or drowsiness of a driver of a road going vehicle comprising a steering system extending between a steering wheel connected to a steering shaft and road engaging steered wheels of the vehicle, the detection system comprising;
a controller mountable on the vehicle;
a first movement sensor mountable on the vehicle, to sense movement of the steering system;
the first sensor being connectable to the controller to provide the controller with a first signal in response to movement of the steering system; and
the controller being configured to generate an output signal, if there has not been movement of the steering system for a first time period.

The first movement sensor may be mounted in a region of the steering wheel or on the shaft to provide the controller with the first signal in response to movement of the steering wheel or shaft and the controller may be configured to generate the output signal, if there has not been movement of the steering wheel or shaft for the first time period.

The system is based on the premise that during normal driving of a vehicle, a driver of the vehicle intermittently, utilizing the steering wheel, makes adjustments to the road engaging steered wheels, in order to keep the vehicle on the road. Should the driver loose concentration or fall asleep, there will be no such adjustments during the first time period. The system is hence configured to detect if no adjustment is made via the steering wheel during the first time period, and the controller then generates the output signal.

The first movement sensor may be adapted to detect and measure rotational movement of the steering wheel or shaft.

The controller may be connected to an indicator arrangement and the output signal may cause energization or activation of the indicator arrangement. The indicator arrangement may comprise an audible alarm and/or a visible indicator mountable in the vehicle. In other embodiments the controller may be connected to any other suitable reaction or reactive device and the output signal may cause the device to be activated.

The system may comprise a timer connected to or cooperating with the controller and for timing out the first time period.

The first time period may be programmable and may be vehicle speed dependent.

The controller may be configured to reset the timer each time a first signal is received from the first sensor.

However, in a preferred embodiment, the controller is configured to discriminate between an event of a first kind wherein movement sensed by the first sensor is caused by the steering wheel and an event of a second kind wherein movement sensed by the first sensor is induced by another source, such as a road engaging wheel, for example when an irregularity in the road surface is engaged by the road engaging wheel, and wherein the timer is reset when an event of the first kind is detected only.

The system may be mounted on the vehicle at the time of manufacture, alternatively the system may be retrofitted to the vehicle. The system may be provided in the form of a kit, so that it may be retrofitted to a vehicle.

Also included in within the scope of the present invention is a method of assisting a driver of a vehicle, the method comprising the steps of:
sensing for movement of a part of a steering system originating from the steering wheel of the vehicle; and
automatically activating a reactive device if such movement has not been detected within a first time period.

The method may comprise the step of distinguishing between an event of a first kind wherein movement of the part of the steering system originates from manipulation of the steering wheel and an event of a second kind wherein movement of the part of the steering system originates from another source, such as a road engaging wheel of the vehicle, and wherein the reactive device is activated if an event of the first kind has not been detected within said first time period.

### BRIEF DESCRIPTION OF THE ACCOMPANYING DIAGRAMS

The invention will now further be described, by way of example only, with reference to the accompanying diagrams wherein

FIG. 1 is a basic block diagram of a detection and warning system according to the invention for a driver of a vehicle;

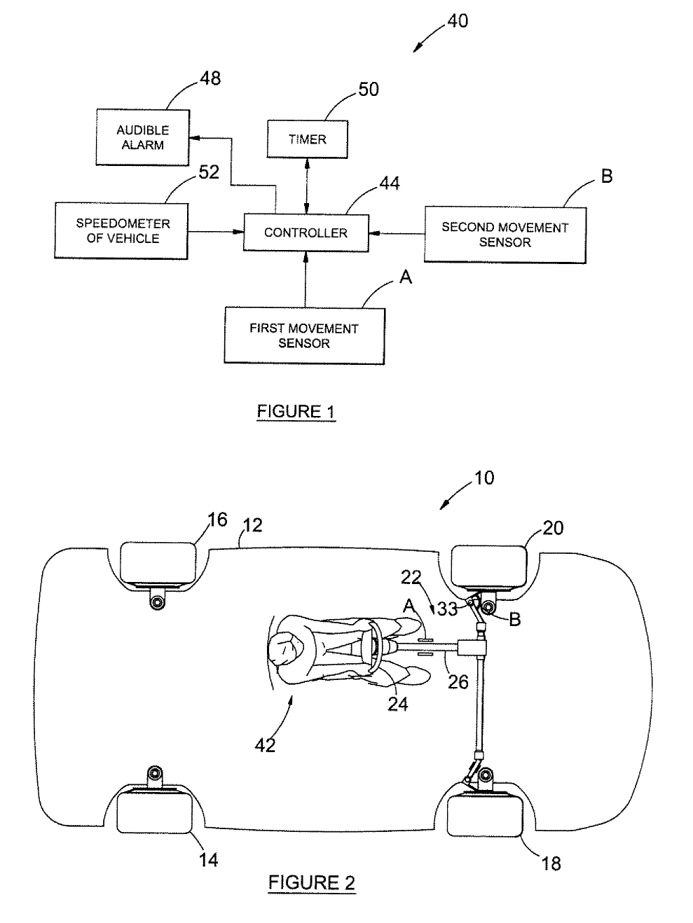

FIG. 2 is a diagram of relevant parts of one typical vehicle also illustrating parts of the system in FIG. 1;

FIG. 2A is a more detailed front view of a steering system of the vehicle;

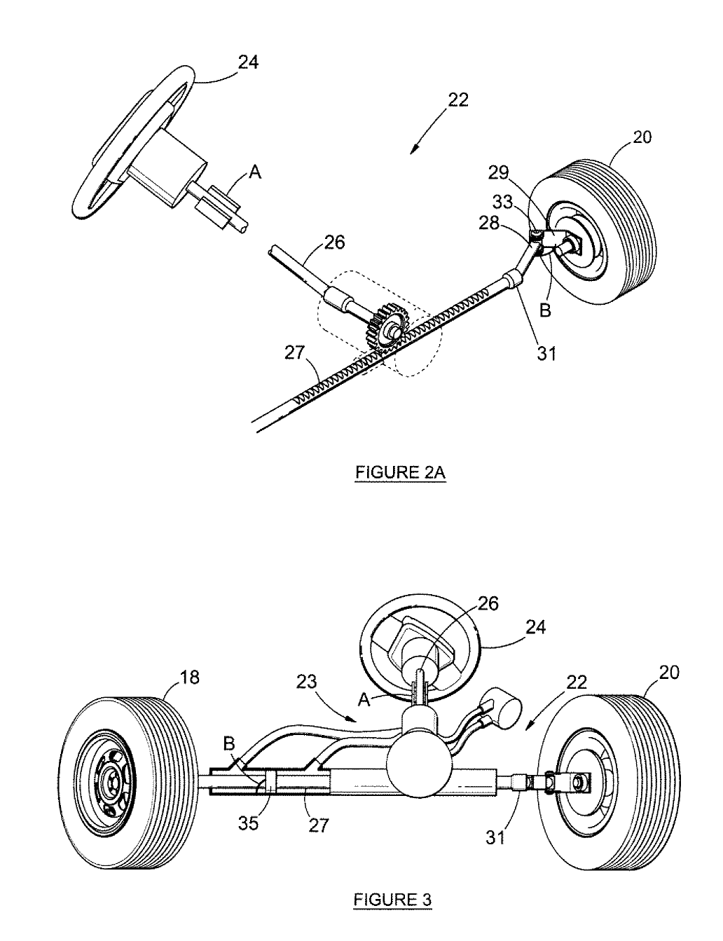

FIG. 3 is a similar view of another typical vehicle;

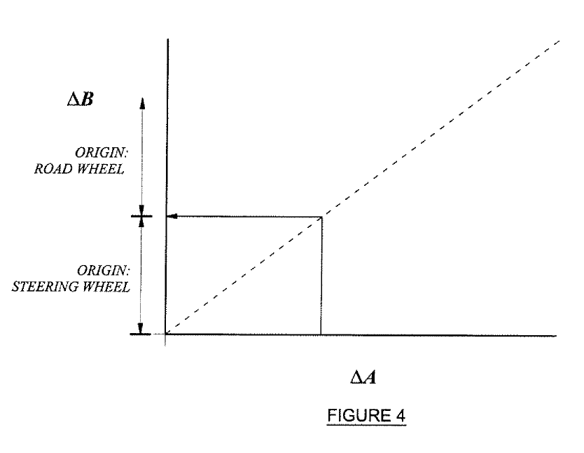

FIG. 4 is a graph of an exemplary relationship of movement detected by a first sensor forming part of the system according to the invention and corresponding anticipated movement at a second sensor forming part of the system according to the invention; and

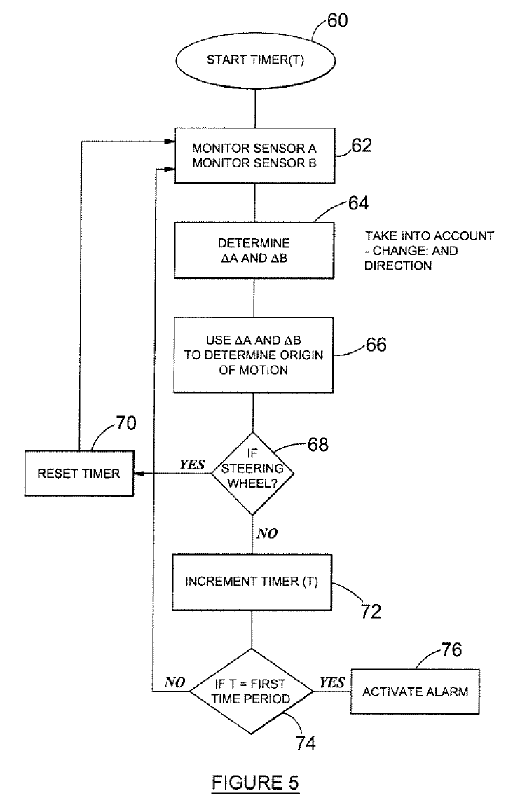

FIG. 5 is a basic flow diagram of a computer program executed by a controller forming part of the system.

### DESCRIPTION OF A PREFERRED EMBODIMENT OF THE INVENTION

Relevant parts of a known road going vehicle are generally designated by the reference numeral 10 in FIG. 2.

The vehicle 10 comprises a chassis 12 mounted on two rear wheels 14 and 16 and two, driver manipulatable, road-engaging front steered wheels 18 and 20. The steered wheels 18 and 20 are manipulatable by a steering system 22 comprising a steering wheel 24, a steering shaft 26 connected to the steering wheel 24 to convert rotational movement of the steering wheel 24 and shaft 26 into steering torque at kingpins (not shown, but well known in the art) of the steered wheels. As is well known in the art, the steered wheels enable steering of the vehicle by a driver 42 of the vehicle.

Various forms of the steering system 22 are known in the art. These include a rack and pinion configuration as shown in FIG. 2A, recirculating ball (not shown) and worm and sector (also not shown).

Power steering systems as shown in FIG. 3, comprise a hydraulic system to facilitate manipulation of the steering system 22 by the driver. In the rack and pinion configuration of FIG. 2A, the rack 27 is connected by joints 31 at the ends thereof, to tie rods 28. The tie rods 28 are connected to steering arms 29. Each of these steering systems comprises links, which are inter-connected by joints. The joins may be pivotable joins 33 or linear or telescopic joints 35, such as that in the case of a piston and cylinder in the case of the power steering system shown in FIG. 3. At least some of these joints are associated with inherent play or movement transmission losses. Hence there is play in the steering system 22 between the steering wheel 24 and the steered wheels 18,20.

As stated in the introduction of this specification, many accidents are caused by the fact that a driver 42 of a vehicle may fall asleep and loose control over the vehicle 10, which may result in a collision or the like. Various road marking techniques to alleviate this problem are known, and their disadvantages are also referred to in the introduction of this specification.

Referring to FIGS. 1 and 2, according to the present invention, a detection and warning system 40 for a driver 42 (shown in FIG. 2) of a vehicle 10 comprises a computerized or processor driven controller 44 mounted on the vehicle. A first movement sensor, preferably a rotational movement sensor A is mounted in a region of the steering system 22 towards the steering wheel 24 and steering shaft 26, preferably on the steering wheel 24 or shaft 26, to sense for rotational movement of the steering wheel 24 or shaft 26. The first sensor A is connected to the controller to provide the controller with a first signal in response to rotational movement of the shaft and corresponding to movement sensed or measured by the first sensor. An indicator arrangement or reactive device such as an alarm 48, preferably in the form of an audible and/or visible alarm, is connected to the controller 44. The controller 44 is configured automatically to generate an output signal to activate the reactive device or energize the alarm 48, if there has not been rotational movement of the shaft 26 originating from the steering wheel 24 for a first predetermined and programmable time period. The system and method according to the invention are based on the assumption that in the absence of rotational movement of the shaft 26 during the first time period, the driver probably has lost concentration or may have fallen asleep, and the controller 44 is configured to energize the alarm, to warn, alert and/or awaken the driver.

The system comprises a timer 50 connected to the controller 44. The timer 50 is operative to time out the first time period. The controller 44 is connected to a speedometer 52 of the vehicle to receive signals or data relating to the speed of travel of the vehicle, for use by the controller 44 as hereinafter described.

The system preferably comprises at least one further sensor in the form of a second movement sensor B mounted on the steering system 22 in a region thereof towards at least one of the road engaging wheels 18,20 and to span at least one suitable joint 33,35 in the steering system 22 having play or movement transmission losses or to interface with at least one such suitable joint in the steering system 22. The second sensor B is also connected to the controller 44. The second sensor is sensitive to movement of the steering system 22 in the region where it is mounted and responsive to provide to the controller a second signal corresponding to movement sensed by the second sensor. The controller 44 is configured to distinguish between an event of a first kind wherein rotation of the shaft 26 is caused by the steering wheel 24 and an event of a second kind wherein rotation of the shaft 26 is induced from the wheels 18, 20, for example as a result of the wheels having negotiated an irregularity in or on the road.

When the steering wheel 24 is turned by driver 42, the shaft 26 is rotated through ΔA degrees. This causes a corresponding anticipated change in movement at sensor B of ΔB to be detected by sensor B. The relationship may be a function of steering ratio (which may be high, neutral or low, depending on the vehicle) and may be established empirically for the position of sensor B. An exemplary graphical representation of a possible relationship is show in FIG. 4. If the origin of motion causing rotation of shaft 26 is the steering wheel 24, the resulting change expected to be measured by sensor B, should be equal to or smaller than the aforementioned corresponding value. Due to losses or play in the joints in the steering system 22, it may be smaller. However, if the origin of motion causing rotation of shaft 26 is another source, more particularly at a road engaging wheel 18,20, it is expected that the value of ΔB measured, would be larger than the aforementioned corresponding value for the measured change ΔA. Hence, one exemplary way of distinguishing between an event of the first kind and an event of the second kind is to determine the values of ΔA and ΔB and to compare them as will hereinafter be described in more detail.

The controller 44 executes an application program for receiving the first and second signals corresponding to measured values of ΔA and ΔB from sensors A and B respectively, for processing the values and from the processing to determine the origin of the motion causing rotation of shaft 26. A simplified flow diagram of basic operation of the program is shown in FIG. 5. At 60 the timer 50 is started. At 62, the controller monitors sensors A and B and at 64, the controller 44 determines values for ΔA and ΔB taking into account change and direction of change. At 66, the origin of the motion is determined as will hereinafter be described. If at 68 it is determined by the controller that the origin of the motion is the steering wheel, the timer is reset at 70 and the controller returns to step 62. This means that the driver is probably alert and driving the vehicle properly by making the necessary steering wheel adjustments. However, if at 68 the controller determines that that the origin is a road-engaging wheel 18,20, the timer is incremented at 72. If at 74, the controller determines that the aforementioned first time period has been timed out without any motion originating from the steering wheel 24, the controller causes the alarm 48 to be activated, thereby to alert the driver 42 as aforesaid. However, if the first time period has not yet been timed out, the controller returns to step 62 and the aforementioned steps are repeated.

The determination at step 64 may involve: comparing by means of a comparator the measured value of ΔB to the anticipated corresponding value of ΔB for the measured value of ΔA. If the measured value of ΔB is equal or smaller than the aforementioned corresponding value for the measured A and which corresponding value for ΔB may be computed or retrieved from a look-up table, the origin would be the steering wheel. However, if the measured value ΔB is larger than the aforementioned corresponding value, the origin is assumed to be a road-engaging wheel.

In other applications or embodiments, relative timing of receipt of the first and second signals respectively at the controller 44 may be used to distinguish between an event of the first kind and an event of the second kind, that is to determine whether the origin of the motion is the steering wheel 24 or a road engaging wheel 18,20.

As stated herein before, the controller 44 is configured to reset the timer 52, each time an event of the first kind is detected by the controller, which means the driver is alert and is adjusting the steering as would be expected. However, an event of the second kind says nothing about the alertness of the driver and the timer continues to time out the first time period even if events of the second kind are detected. As stated hereinbefore, once the timer 52 has timed out the first time period, the controller 44 generates the output signal and causes the alarm 48 to be energized.

The length of first time period may be selectable or programmable to suit a particular type of vehicle and the speed of travel. It may typically be between 3-15 seconds. The value may be automatically adjusted by the controller in accordance with the speed of travel derived from the speedometer 52. The first time period may have a first value for vehicle speeds in a first range or band, a second shorter value for vehicle speeds in a second higher range or band, a third even smaller value for vehicle speeds in a third even higher range or band of vehicle speeds, etc.

The detection system 40 may be mounted on the vehicle 10 at the time of manufacture, alternatively the system 40 may be retrofitted to the vehicle. The system 40 may be provided in the form of a kit, so that it may be retrofitted to a vehicle.

1. A detection system for detecting loss of concentration of a driver of a road going vehicle comprising a steering system extending between a steering wheel connected to a steering shaft and road engaging steered wheels of the vehicle, the detection system comprising;
a controller mountable on the vehicle;
a first movement sensor mountable on the vehicle, to sense movement of the steering system;
the first sensor being connected to the controller to provide the controller with a first signal in response to movement of the steering system;
the controller being configured to discriminate between an event of a first kind wherein movement sensed by the first sensor is caused by the steering wheel and an event of a second kind wherein movement sensed by the first sensor is induced by another source; and
the controller being configured to generate an output signal if there has not been a event of the first kind for a first time period.

2. A detection system as claimed in claim 1, wherein the first sensor is mounted in a region of the steering wheel or on the shaft to provide the controller with the first signal in response to movement of the steering wheel or shaft.

3. A detection system as claimed in claim 1, wherein the first sensor is configured to detect and measure rotational movement.

4. A detection system as claimed in claim 1, wherein the controller is connected to a reactive device and the output signal is operative to cause activation of the reactive device.

5. A detection system as claimed in claim 1,
comprising a timer cooperating with the controller and for timing out the first time period,

6. A detection system as claimed in claim 1,
wherein the first time period is programmable.

7. A detection system as claimed in claim 1, comprising a second movement sensor mounted in a region of the steering system towards a road engaging wheel of the vehicle, the second sensor being connected to the controller to provide a second signal to the controller when motion is detected by the second sensor, the controller being configured to distinguish between an event of the first kind and an event of the second kind based on the first and second signals.

8. A detection system as claimed in claim 7, wherein the second sensor is mounted to interface with a region of play between two parts of the steering system and wherein the controller is configured to distinguish between an event of the first kind and an event of the second kind based respective values of change as a result of movement as sensed by the first and second sensors respectively.

9. A detection system as claimed in claim 7, wherein the controller is configured to distinguish between an event of the first kind and an event of the second kind based on the relative timing of reception by the controller of the first and second signals.

10. A detection system as claimed in claim 5, wherein the controller is configured to reset the timer on detection of an event of the first kind only.

11. A kit comprising a detection system as claimed in claim 1.

12. A vehicle comprising a detection system as claimed in claim 1.

13. A method of assisting a driver of a vehicle, the method comprising the steps of:
sensing for movement of a part of a steering system;
distinguishing between an event of a first kind wherein movement of the part of the steering system originates from manipulation of a steering wheel of the vehicle and an event of a second kind wherein movement of the part of the steering system originates from another source; and
automatically activating a reactive device if an event of the first kind has not been detected within a first time period.
